(19) United States
(12) Patent Application Publication
(10) Pub. No.: US 2002/0073571 A1
(43) Pub. Date: Jun. 20, 2002

(54) Measuring device

(76) Inventor: Michael P. Brannon SR., Spartanburg, SC (US)

Correspondence Address: Kaardal & Associates, PC, Attn: Ivar M. Kaardal, 3500 South First Ave. Circle - Suite 250, Sioux Falls, SD, 57105-5802, US

(21) Appl. No.: 09/737,788

(22) Filed: Dec. 15, 2000

(51) Int. Cl. G01C 15/02

(52) U.S. Cl. 33/809; 33/406; 33/413; 33/1 G

(57) ABSTRACT

A measuring device for simplifying surveying and leveling work. The measuring device includes a multiple-sided elongate member; and also includes a sleeve member being movably disposed about the multiple-sided elongate member; and further includes a fastening assembly for fastening the sleeve member to the multiple-sided elongate member.

### BACKGROUND OF THE INVENTION

1. Field of the Invention

The present invention relates to an adjustable measuring device and more particularly pertains to a new measuring device for simplifying surveying and leveling work.

2. Description of the Prior Art

The use of an adjustable measuring device is known in the prior art. More specifically, an adjustable measuring device heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 4,216,585 U.S. Pat. No. 4,165,566; U.S. Pat. No. 2,336,393; U.S. Pat. No. 5,497,560; U.S. Pat. No. 5,642,569; and U.S. patent No. Des. 350,489.

While these devices fulfill their respective, particular objectives and requirements, the aforementioned patents do not disclose a new measuring device. The inventive device includes a multiple-sided elongate member; and also includes a sleeve member being movably disposed about the multiple-sided elongate member; and further includes a fastening assembly for fastening the sleeve member to the multiple-sided elongate member.

In these respects, the measuring device according to the present invention substantially departs from the conventional concepts and designs of the prior art, and in so doing provides an apparatus primarily developed for the purpose of simplifying surveying and leveling work.

### SUMMARY OF THE INVENTION

In view of the foregoing disadvantages inherent in the known types of adjustable measuring device now present in the prior art, the present invention provides a new measuring device construction wherein the same can be utilized for simplifying surveying and leveling work.

The general purpose of the present invention, which will be described subsequently in greater detail, is to provide a new measuring device which has many of the advantages of the adjustable measuring device mentioned heretofore and many novel features that result in a new measuring device which is not anticipated, rendered obvious, suggested, or even implied by any of the prior art adjustable measuring device, either alone or in any combination thereof.

To attain this, the present invention generally comprises a multiple-sided elongate member; and also includes a sleeve member being movably disposed about the multiple-sided elongate member; and further includes a fastening assembly for fastening the sleeve member to the multiple-sided elongate member.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new measuring device which has many of the advantages of the adjustable measuring device mentioned heretofore and many novel features that result in a new measuring device which is not anticipated, rendered obvious, suggested, or even implied by any of the prior art adjustable measuring device, either alone or in any combination thereof.

It is another object of the present invention to provide a new measuring device which may be easily and efficiently manufactured and marketed.

It is a further object of the present invention to provide a new measuring device which is of a durable and reliable construction.

An even further object of the present invention is to provide a new measuring device which is susceptible of a low cost of manufacture with regard to both materials and labor, and which accordingly is then susceptible of low prices of sale to the consuming public, thereby making such measuring device economically available to the buying public.

Still yet another object of the present invention is to provide a new measuring device which provides in the apparatuses and methods of the prior art some of the advantages thereof, while simultaneously overcoming some of the disadvantages normally associated therewith.

Still another object of the present invention is to provide a new measuring device for simplifying surveying and leveling work.

Yet another object of the present invention is to provide a new measuring device which includes a multiple-sided elongate member; and also includes a sleeve member being movably disposed about the multiple-sided elongate member; and further includes a fastening assembly for fastening the sleeve member to the multiple-sided elongate member.

Still yet another object of the present invention is to provide a new measuring device that accurately measures distances between the ground and the flexible line.

Even still another object of the present invention is to provide a new measuring device that is easy and convenient to adjust to a desired depth setting.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new measuring device according to the present invention.

FIG. 2 is a detailed partial front elevational view of the present invention.

FIG. 3 is a partial cross-sectional view of the present invention.

### DESCRIPTION OF THE PREFERRED EMBODIMENT

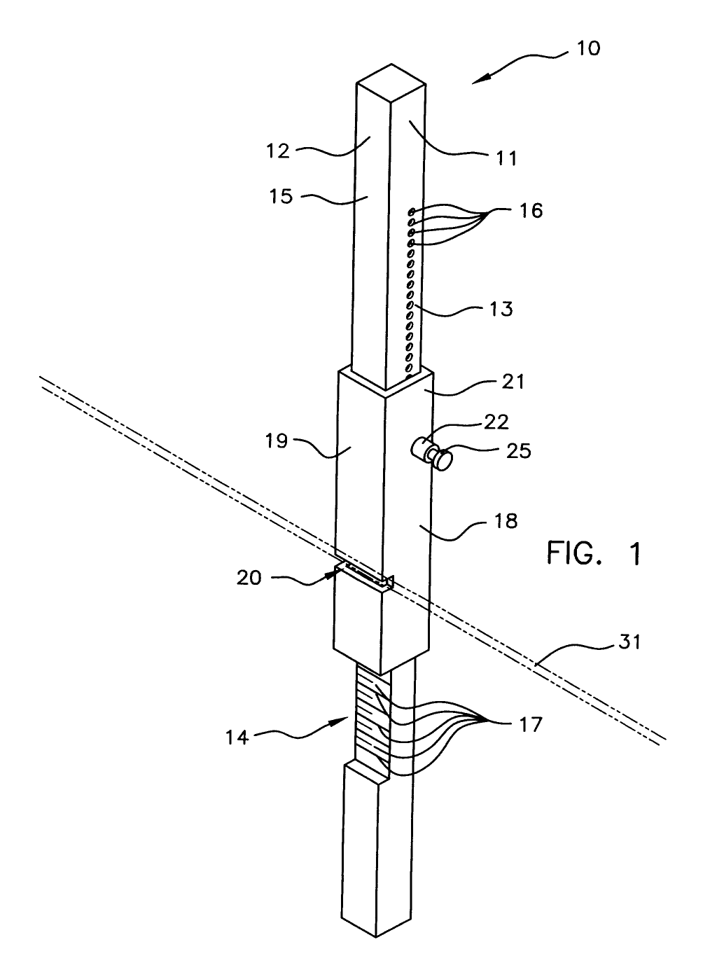

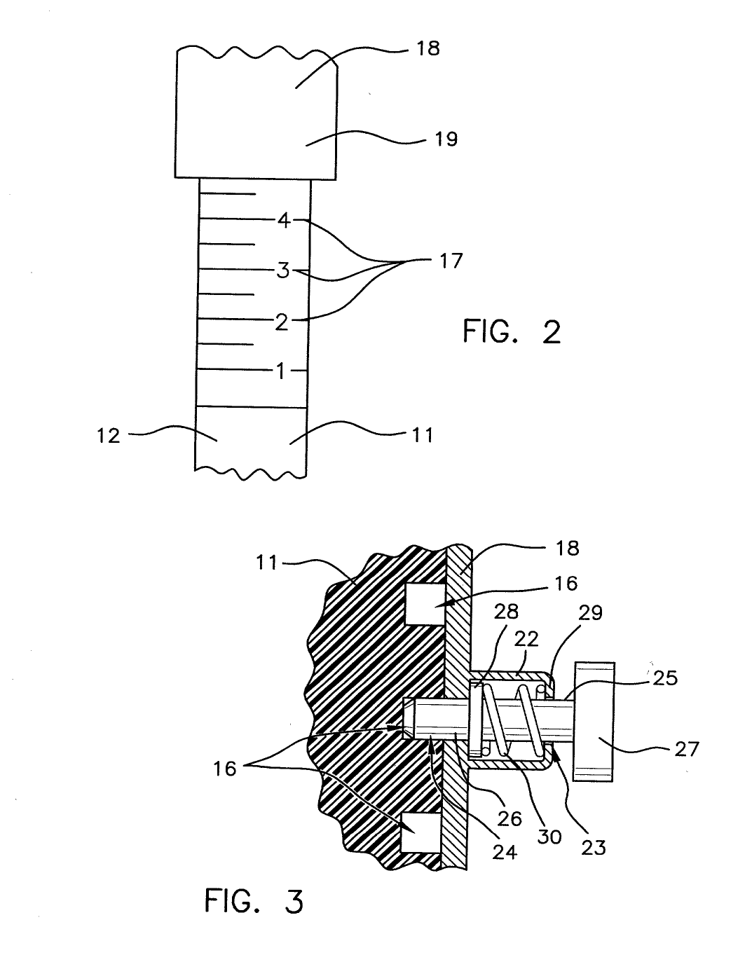

With reference now to the drawings, and in particular to FIGS. 1 through 3 thereof, a new measuring device embodying the principles and concepts of the present invention and generally designated by the reference numeral 10 will be described.

As best illustrated in FIGS. 1 through 3, the measuring device 10 generally comprises a multiple-sided elongate member 11 having a first side 12 and a second side 13. The first side 12 has a measuring scale 17 conventionally disposed thereupon. The second side 12 has a plurality of holes 16 being conventionally disposed therein. The multiple-side elongate member 11 has a recessed middle portion 14 being disposed in the first side 12 thereof. The measuring scale 17 is conventionally disposed upon and along the recessed middle portion 14. The measuring scale 17 includes a plurality of graduated marks 17 being spaced apart and being disposed along the recessed middle portion 14. The holes 16 are spaced apart and aligned along an upper portion 15 of the multiple-sided elongate member 11. The multiple-sided elongate member 11 has a length of approximately 3 feet with, the graduated marks 17 being spaced apart in increments of ½ inch.

A sleeve member 18 is movably disposed about the multiple-sided elongate member 11. The sleeve member 18 includes a laterally-extending slot 20 being disposed through a first wall 19 thereof, and also includes a boss-like housing 22 being conventionally disposed upon a second wall 21 thereof, and further includes opening 23,24 being aligned and being disposed through a wall 29 of the boss-like housing 22 and through the second wall 21 thereof. The laterally-extending slot 20 is adapted to receive a flexible line 31. The sleeve member 18 has a cross-section of approximately 2 inches by 2 inches.

A fastening assembly for fastening the sleeve member 18 to the multiple-sided elongate member 11 includes a peg-like member 25 having a shaft portion 26, a head portion 27, and an annular flange 28 being securely and conventionally disposed about the shaft portion 26 and being spaced from the head portion 27, and also includes a spring member 30 being disposed between the wall 29 of the boss-like housing 22 and the annular flange 28 for biasing the peg-like member 25 through the opening 24 of the second wall 21 of the sleeve member 18 and into one of the holes 16 of the multiple-sided elongate member 11.

In use, the user slides the sleeve member 11 along the multiple-side elongate member 11 and inserts the peg-like member 25 into one of the holes 16 in the multiple-sided elongate member 11 for the desired depth setting for a flexible line 31 being retained in the laterally-extending slot 20 and the ground for surveying and leveling purposes.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A measuring device comprising:
a multiple-sided elongate member;
a sleeve member being movably disposed about said multiple-sided elongate member; and
a fastening assembly for fastening said sleeve member to said multiple-sided elongate member.

2. A measuring device as described in claim 1, wherein said multiple-sided elongate member has a first side and a second side, said first side having a measuring scale disposed thereupon, said second side having a plurality of holes disposed therein.

3. A measuring device as described in claim 2, wherein said multiple-side elongate member has a recessed middle portion disposed in said first side, said measuring scale being disposed upon said recessed middle portion.

4. A measuring device as described in claim 3, wherein said measurement scale includes a plurality of graduated marks being spaced apart and being disposed along said recessed middle portion.

5. A measuring device as described in claim 4, wherein said graduated marks are spaced apart in increments of approximately ½ inch.

6. A measuring device as described in claim 2, wherein said holes are spaced apart and aligned along an upper portion of said multiple-sided elongate member.

7. A measuring device as described in claim 4, wherein said sleeve member includes a laterally-extending slot being disposed through a first wall thereof, and also includes a boss-like housing being disposed upon a second wall thereof, and further includes openings being aligned and being disposed through a wall of said boss-like housing and through said second wall thereof, said laterally-extending slot being adapted to receive a flexible line.

8. A measuring device as described in claim 7, wherein said fastening assembly includes a peg-like member having a shaft portion, a head portion, and an annular flange being securely disposed about said shaft portion and being spaced from said head portion, and also includes a spring member being disposed between said wall of said boss-like housing and said annular flange for biasing said peg-like member through said opening of said second wall of said sleeve member and into one of said holes of said multiple-sided elongate member.

9. A measuring device comprising:
a multiple-sided elongate member, said multiple-sided elongate member having a first side and a second side, said first side having a measuring scale disposed thereupon, said second side having a plurality of holes disposed therein, said multiple-side elongate member having a recessed middle portion disposed in said first side, said measuring scale being disposed upon said recessed middle portion, said measuring scale including a plurality of graduated marks being spaced apart and being disposed along said recessed middle portion, said holes being spaced apart and being aligned along an upper portion of said multiple-sided elongate member, said multiple-sided elongate member having a length of approximately 3 feet, said graduated marks being spaced apart in increments of ½ inch;
a sleeve member being movably disposed about said multiple-sided elongate member, said sleeve member including a laterally-extending slot being disposed through a first wall thereof, and also including a boss-like housing being disposed upon a second wall thereof, and further including openings being aligned and being disposed through a wall of said boss-like housing and through said second wall thereof, said laterally-extending slot being adapted to receive a flexible line, said sleeve member having a cross-section of approximately 2 inches by 2 inches; and
a fastening assembly for fastening said sleeve member to said multiple-sided elongate member, said fastening assembly including a peg-like member having a shaft portion, a head portion, and an annular flange being securely disposed about said shaft portion and being spaced from said head portion, and also including a spring member being disposed between said wall of said boss-like housing and said annular flange for biasing said peg-like member through said opening of said second wall of said sleeve member and into one of said holes of said multiple-sided elongate member.
